(19) United States
(12) Patent Application Publication
(10) Pub. No.: US 2015/0048747 A1
(43) Pub. Date: Feb. 19, 2015

(54) STRUCTURE OF COLOR MIXING CIRCUIT OF LED LIGHT STRING

(71) Applicant: Mei-Ling Peng, Hsinchu City (TW)

(72) Inventor: Mei-Ling Peng, Hsinchu City (TW)

(21) Appl. No.: 13/968,405

(22) Filed: Aug. 15, 2013

(51) Int. Cl. H05B 33/08

(52) U.S. Cl. CPC H05B 33/0857
USPC 315/192

(57) ABSTRACT

Disclosed is a structure of a color mixing circuit of an LED light. The LED light includes two input pins that are respectively an input pin of two light emitting chips of four primary color light emitting chips of R, G, B, and Y that are connected in parallel and opposite in direction and an input pin of the remaining two light emitting chips that are connected in parallel and opposite in direction; and two output pins that are respectively an output pin of the two light emitting chips of the four primary color light emitting chips of R, G, B, and Y that correspond to one of the input pins and are connected in parallel and opposite in direction and an output pin of the remaining two light emitting chips that correspond to another one of the input pins and are connected in parallel and opposite in direction.

### TECHNICAL FIELD OF THE INVENTION

The present invention generally relates to an electrical connection structure of light-emitting chips of an LED light, and more particularly to an electrical connection structure of light-emitting chips of four primary colors R (Red), G (Green), B (Blue), and Y (Yellow) of an LED light string.

### DESCRIPTION OF THE PRIOR ART

In the known techniques of LED lights that use color light emitting chips, the structure of electrical connection among the light-emitting chips of four primary colors R, G, B, and Y is often a parallel connection structure of common cathode or common anode, as shown in FIGS. 1 and 2. In certain application, it might need to connect a group of LED light strings in series for use, such as a light bar or a color light string for decoration purposes. The known techniques have a drawback that it is not possible to realize synchronous color change for the color light emitting chips when the LED light strings are connected in series. The known electrical connection structure of the primary color light emitting chips of an LED light uses four integrated circuits (ICs) to respectively control the four color light emitting chips of R, G, B, and Y. This increases the manufacture cost.

### SUMMARY OF THE INVENTION

To overcome the technical drawbacks that the known techniques cannot realize synchronous color change of the primary color light emitting chips for applications where LED light strings are connected in series and that an electrical connection structure adopted conventionally for the primary color light emitting chips of an LED light needs four ICs to respectively control the four primary color light emitting chips of R, G, B, and Y thereby increasing the manufacture cost, the present invention provides an electrical connection structure of light emitting chips of an LED light that reduces the number of IC control chips and realize synchronous color change of the chips.

The solution adopted in the present invention is that in a structure of an LED light that comprises four primary color light emitting chips of R, G, B, and Y, the LED light comprises two input pins and two output pins.

The advantage of the present invention is that the structure is simple and realizes reduction of the number of IC control chips and synchronous color change of the light emitting chips in applications where a group of LED light strings are connected in series through only modifications made in the electrical connection arrangement among the four primary color light emitting chips of R, G, B, and Y.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a circuit diagram illustrating a conventional common anode connection among four color light emitting chips of R, G, B, and Y of an LED light.

FIG. 2 is a circuit diagram illustrating a conventional common cathode connection among four color light emitting chips of R, G, B, and Y of an LED light.

FIG. 3 is a circuit diagram illustrating a connection among four color light emitting chips of R, G, B, and Y according to a first embodiment of the present invention.

FIG. 4 is a circuit diagram illustrating a connection among four color light emitting chips of R, G, B, and Y according to a second embodiment of the present invention.

FIG. 5 is a circuit diagram illustrating a connection among four color light emitting chips of R, G, B, and Y according to a third embodiment of the present invention.

FIG. 6 is a circuit diagram illustrating a connection among four color light emitting chips of R, G, B, and Y according to a fourth embodiment of the present invention.

FIG. 7 is a circuit diagram illustrating a connection used in an application according to the present invention.

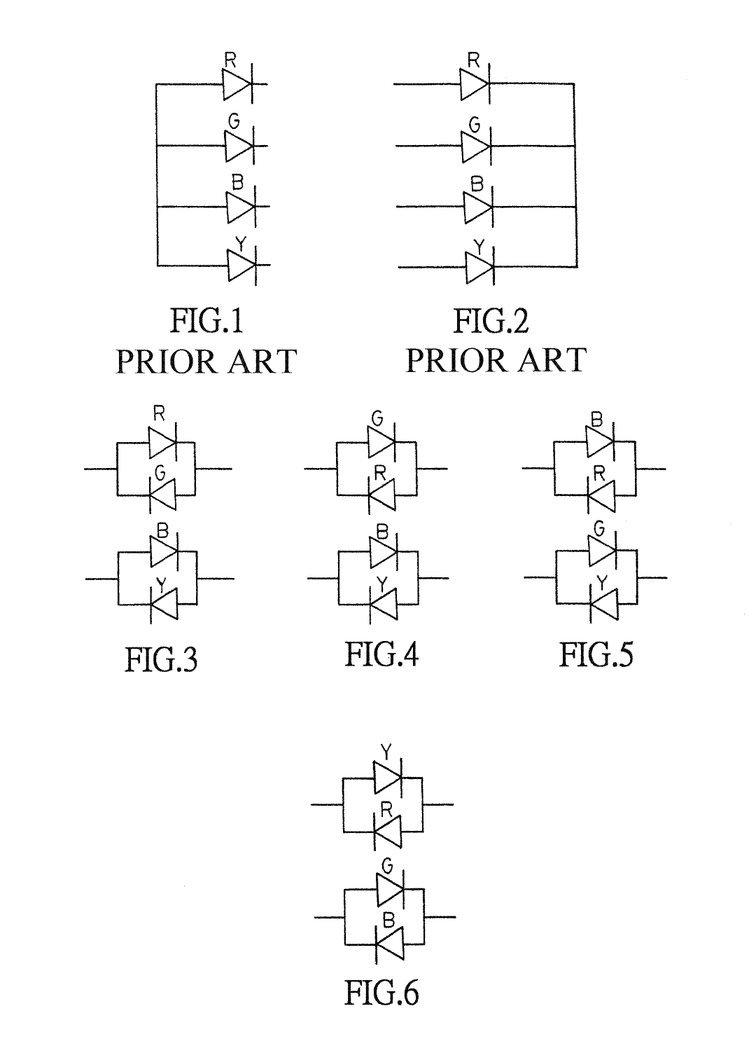

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to the drawings, the present invention provides a structure of a color mixing circuit of an LED light, which comprises four primary color light emitting chips of R, G, B, and Y. The LED light is provided with two input pins and two output pins. The two input pins are respectively an input pin of any two light emitting chips of the four primary color light emitting chips of R, G, B, and Y that are connected in parallel and opposite in direction and an input pin of the remaining two light emitting chips that are connected in parallel and opposite in direction. The two output pins are respectively an output pin of the two light emitting chips of the four primary color light emitting chips of R, G, B, and Y that correspond to one of the input pins and are connected in parallel and opposite in direction and an output pin of the remaining two light emitting chips that correspond to another one of the input pins and are connected in parallel and opposite in direction.

With the four primary color light emitting chips of R, G, B, and Y connected with the above described arrangement, it is possible to use two ICs to respectively control two parallel-connected light emitting chips and another independent light emitting chip, so that it can cut one IC control chip and realize synchronous color change.

Referring to FIG. 3, in a first embodiment of the present invention, the connection structure of the four primary color light emitting chips of R, G, B, and Y is that the two input pins are respectively an input pin of parallel-connected anode of the R primary color light emitting chip and cathode of the G primary color light emitting chip and an input pin of parallel-connected anode of the B primary color light emitting chip and cathode of the Y primary color light emitting chip; and the two output pins are respectively an output pin of parallel-connected cathode of the R primary color light emitting chip and anode of the G primary color light emitting chip and an output pin of parallel-connected cathode of the B primary color light emitting chip and anode of the Y primary color light emitting chip.

Referring to FIG. 4, in a second embodiment of the present invention, the connection structure of the four primary color light emitting chips of R, G, B, and Y is that the two input pins are respectively an input pin of parallel-connected anode of the G primary color light emitting chip and cathode of the R primary color light emitting chip and an input pin of parallel-connected anode of the B primary color light emitting chip and cathode of the Y primary color light emitting chip; and the two output pins are respectively an output pin of parallel-connected cathode of the G primary color light emitting chip and anode of the R primary color light emitting chip and an output pin of parallel-connected cathode of the B primary color light emitting chip and anode of the Y primary color light emitting chip.

Referring to FIG. 5, in a third embodiment of the present invention, the connection structure of the four primary color light emitting chips of R, G, B, and Y is that the two input pins are respectively an input pin of parallel-connected anode of the B primary color light emitting chip and cathode of the R primary color light emitting chip and an input pin of parallel-connected anode of the G primary color light emitting chip and cathode of the Y primary color light emitting chip; and the two output pins are respectively an output pin of parallel-connected cathode of the B primary color light emitting chip and anode of the R primary color light emitting chip and an output pin of parallel-connected cathode of the G primary color light emitting chip and anode of the Y primary color light emitting chip.

Referring to FIG. 6, in a fourth embodiment of the present invention, the connection structure of the four primary color light emitting chips of R, G, B, and Y is that the two input pins are respectively an input pin of parallel-connected anode of the Y primary color light emitting chip and cathode of the R primary color light emitting chip and an input pin of parallel-connected anode of the G primary color light emitting chip and cathode of the B primary color light emitting chip; and the two output pins are respectively an output pin of parallel-connected cathode of the Y primary color light emitting chip and anode of the R primary color light emitting chip and an output pin of parallel-connected cathode of the G primary color light emitting chip and anode of the B primary color light emitting chip.

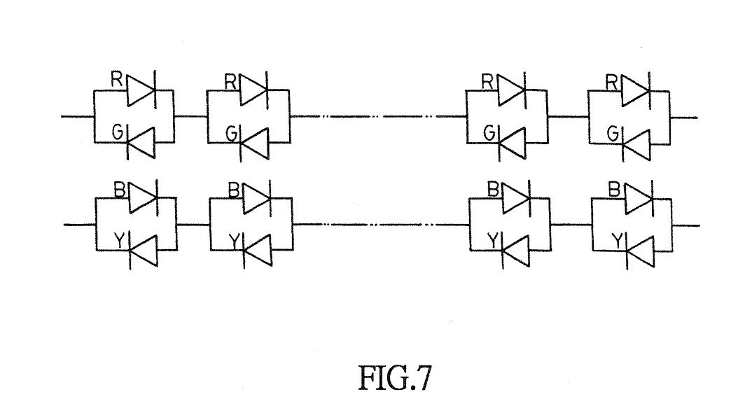

FIG. 7 is a circuit diagram illustrating a connection used in an application according to the present invention. When the present invention is applied to use as a light bar or a color light string, IC control chips can be arranged outside the light bar or the color light string for easy replacement and maintenance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a color mixing circuit of an LED light, characterized in that the LED light comprises two input pins and two output pins, wherein the two input pins are respectively an input pin of two light emitting chips of four primary color light emitting chips of R, G, B, and Y that are connected in parallel and opposite in direction and an input pin of the remaining two light emitting chips that are connected in parallel and opposite in direction; and the two output pins are respectively an output pin of the two light emitting chips of the four primary color light emitting chips of R, G, B, and Y that correspond to one of the input pins and are connected in parallel and opposite in direction and an output pin of the remaining two light emitting chips that correspond to another one of the input pins and are connected in parallel and opposite in direction.

2. The structure of a color mixing circuit of an LED light according to claim 1, characterized in that the two input pins are respectively an input pin of parallel-connected anode of the R primary color light emitting chip and cathode of the G primary color light emitting chip and an input pin of parallel-connected anode of the B primary color light emitting chip and cathode of the Y primary color light emitting chip; and the two output pins are respectively an output pin of parallel-connected cathode of the R primary color light emitting chip and anode of the G primary color light emitting chip and an output pin of parallel-connected cathode of the B primary color light emitting chip and anode of the Y primary color light emitting chip.

3. The structure of a color mixing circuit of an LED light according to claim 1, characterized in that the two input pins are respectively an input pin of parallel-connected anode of the G primary color light emitting chip and cathode of the R primary color light emitting chip and an input pin of parallel-connected anode of the B primary color light emitting chip and cathode of the Y primary color light emitting chip; and the two output pins are respectively an output pin of parallel-connected cathode of the G primary color light emitting chip and anode of the R primary color light emitting chip and an output pin of parallel-connected cathode of the B primary color light emitting chip and anode of the Y primary color light emitting chip.

4. The structure of a color mixing circuit of an LED light according to claim 1, characterized in that the two input pins are respectively an input pin of parallel-connected anode of the B primary color light emitting chip and cathode of the R primary color light emitting chip and an input pin of parallel-connected anode of the G primary color light emitting chip and cathode of the Y primary color light emitting chip; and the two output pins are respectively an output pin of parallel-connected cathode of the B primary color light emitting chip and anode of the R primary color light emitting chip and an output pin of parallel-connected cathode of the G primary color light emitting chip and anode of the Y primary color light emitting chip.

5. The structure of a color mixing circuit of an LED light according to claim 1, characterized in that the two input pins are respectively an input pin of parallel-connected anode of the Y primary color light emitting chip and cathode of the R primary color light emitting chip and an input pin of parallel-connected anode of the G primary color light emitting chip and cathode of the B primary color light emitting chip; and the two output pins are respectively an output pin of parallel-connected cathode of the Y primary color light emitting chip and anode of the R primary color light emitting chip and an output pin of parallel-connected cathode of the G primary color light emitting chip and anode of the B primary color light emitting chip.

6. A structure of a color mixing circuit of an LED light, characterized in that the LED light comprises three input pins and three output pins, wherein two of the input pins are respectively an input pin of two light emitting chips of five primary color light emitting chips of R, G, B, Y, and P that are connected in parallel and opposite in direction and an input pin of another two light emitting chips that are connected in parallel and opposite in direction and the remaining one of the input pins is an anode of the remaining one of the light emitting chips; and two of the output pins are respectively an output pin of the two light emitting chips of the four primary color light emitting chips of R, G, B, and Y that correspond to one of the input pins and are connected in parallel and opposite in direction and an output pin of another two light emitting chips that correspond to another one of the input pins and are connected in parallel and opposite in direction and the remaining one of the output pins is a cathode of the remaining one of the light emitting chips.
